(19) United States
(12) Patent Application Publication
(10) Pub. No.: US 2015/0257166 A1
(43) Pub. Date: Sep. 10, 2015

(54) METHOD AND APPARATUS FOR OPTIMIZING LOCAL WIRELESS CONNECTIVITY FOR POINT-TO-POINT MEDIA STREAMING

(71) Applicant: SAMSUNG ELECTRONICS CO., LTD., Gyeonggi-do (KR)

(72) Inventors: Yaniv WEIZMAN, Tel Aviv Jaffa (IL); NELLY ANDRUSIER, Tel Aviv (IL); Offri GIL, Alfei Menashe (IL); Itai AHIRAZ, Hod Hasharon (IL); DAN SHIRRON, Givaat Ada (IL)

(73) Assignee: SAMSUNG ELECTRONICS CO., LTD., Gyeonggi-do (KR)

(21) Appl. No.: 14/195,914

(22) Filed: Mar. 4, 2014

(51) Int. Cl. H04W 72/08

(52) U.S. Cl. CPC H04W 72/085

(57) ABSTRACT

A method for maintaining the best available quality of a connection between to wireless-enabled devices in a local wireless network, comprises providing: (a) a link (session) tracking subsystem, for tracking the link (session) quality between PtP devices; and, (b) channel and route selection subsystem, for choosing the best channel and route between session peers; and switching to a different channel and/or route when a measured quality indicator triggers a change.

### FIELD OF THE INVENTION

The present invention relates to local wireless networks. More particularly, the invention relates to the optimization of connectivity for point-to-point media streaming.

### BACKGROUND OF THE INVENTION

Within local wireless local area network small environments, such as home or enterprise networks, a typical (point-to-point) PtP communication route between two wireless devices includes one of the following alternatives:
1. Communication path with multiple wireless links with the involvement of one (or more) intermediate nodes. An example is two WiFi devices that communicate with each other via same serving access point (AP) BSS;
2. Direct device to device communication with direct wireless link between the devices.

Current local area networks are typically based on access nodes, such as a WiFi access point (AP), serving as the anchor for most point-to-point (PtP) communication. The introduction of device-to-device (D2D) connectivity technologies, such as WiFi-direct and Tunneled Direct Link Setup (TDLS), enables more efficient and enhanced PtP connectivity with no intervention of an intermediate access node.

The quality of a PtP streaming session is not consistent over time due to variability of interference and congestion conditions within the wireless network. Upon changing interference and congestion over the channel of the PtP session, in order to ensure the best available user experience, the PtP streaming session should be seamlessly moved to better operational mode including alternate (cleaner) channel and/or route.

The art as so far failed to provide solutions that guarantee a continuously wireless PtP media streaming experience, which is the best available under interfered and/or congested wireless local area environment. Solutions exist for mitigating interference and congestion problems, at AP or device levels. For instance, for access points, solutions for dynamic channel switch of the BSS channel have been proposed, according to which on occurrence of interference/congestion over the serving channel, the AP switches to new and better operation channel if such one exists. The switch can be coordinated with its associated clients, using mechanisms such as described within the 802.11h standard for dynamic frequency selection (DFS), or not coordinated where the clients re-associate to the AP over the new operational channel.

For PtP connectivity, the Tunneled Direct Link Setup (TDLS) technology enables two devices to dynamically offload their connectivity to be over direct link instead of traversing via the AP, over same or different channel. It also defines mechanisms to switch to alternate channel over the direct established link.

Another device-to-device technology, WiFi-Direct, enables two devices to setup a direct link communication with the absence of AP, or when devices are not associated to same AP.

Unfortunately, all existing solutions present drawbacks. For access points solutions, the decision to switch the channel of the serving Basic Service Set (BSS) is taken as a global decision, not necessarily optimized for specific PtP session of two devices traversing via it. Also, AP solutions for dynamic channel selection cannot affect the route of an existing PtP session, for example, to offload the session route to be over direct link instead over AP route.

TDLS technology, also provides mechanisms for dynamically offloading a session from the AP route to direct link and to switch channel dynamically over a direct path, but does not provide the core algorithms required to take the transition decisions. These latter are left open for vendors to implement.

Moreover, such decision algorithms implementations are usually not optimized to specific sessions aspects such as:
Different applications streaming characteristics such as video streaming, file sharing, gaming, etc.
State information of application and transport layers are not taken into account.
A-Symmetric streaming between given sender and receiver.
Different interference domains of devices.

As a result, the decision to move to a different operational mode may not be optimal. This, for instance, may include not taking a “look for alternate operational mode” action when required, delaying a decision to look for better alternative and/or moving to an alternative that is not the most suitable one. In such cases, the user experience might be degraded constantly or temporarily.

WiFi-Direct, although providing direct connectivity between devices, does not include support for dynamic channel switching over an existing direct connection. Moreover, it does not include an option to switch the session route to traverse via AP, when the session quality degradation over direct path requires it.

It is therefore clear that it would be highly desirable to provide better optimized PtP streaming solutions that dynamically select the best operational mode (channel and route) under interfered and congested network, and continuously ensures the best available quality of a streaming session.

It is an object of the present invention to provide a method that overcomes the drawbacks of the prior art and that allows an improved management of connection quality. Other advantages and objects of the invention will become apparent as the description proceeds.

### SUMMARY OF THE INVENTION

The invention relates to a method for maintaining the best available quality of a connection between to wireless-enabled devices in a local wireless network, comprising providing:
a. A link (session) tracking subsystem, for tracking the link (session) quality between PtP devices; and
b. A channel and route selection subsystem, for choosing the best channel and route between session peers;
   and switching to a different channel and/or route when a measured quality indicator triggers a change.

According to one embodiment of the invention, during work on a specific channel/route, statistics/measurements are collected for every candidate operational mode (channel and/or route) from the application and WiFi driver (MAC/PHY) layers, and wherein said measurements are used to trigger a change. In another embodiment of the invention measurements and combinations thereof are gathered either on the sender side, or on the receiver side, or on both sides.

According to a further embodiment of the invention the channel selection criteria are based on a cost function. For example, the candidate session route can be via AP and the cost function is given by the following equations:

$${CostFunction}_{AP} = [ \begin{matrix}\frac{1}{{SINR}_{S \to AP} \cdot {BW}_{S , AP} ( 1 - max ( {( \frac{{T}_{on}}{{T}_{total}} )}_{S} , {( \frac{{T}_{on}}{{T}_{total}} )}_{AP} ) )} + \\ {SINR}_{AP \to R} \cdot {BW}_{AP , R} \cdot ( 1 - max ( {( \frac{{T}_{on}}{{T}_{total}} )}_{R} , {( \frac{{T}_{on}}{{T}_{total}} )}_{AP} ) )\end{matrix}$$

wherein:
SINR_{S→AP}—The SINR in AP from sender device to AP
Br_{S,AP}—The channel bandwidth between sender device and AP
SINR_{AP→R}—The SINR in receiver device from AP to receiver device
BW_{AP,R}—The channel bandwidth between AP and receiver device

$${( \frac{{T}_{on}}{{T}_{total}} )}_{R -}$$

The channel usage seen at the receiver

$$( 0 \leq \frac{{T}_{on}}{{T}_{total}} \leq 1 ) .$$

If current session route is via AP, channel usage shall not include the load from session over current channel.

$${( \frac{{T}_{on}}{{T}_{total}} )}_{S -}$$

The channel usage seen at the sender

$$( 0 \leq \frac{{T}_{on}}{{T}_{total}} \leq 1 ) .$$

If current route is via AP, channel usage shall not include the load from session over current channel.

$${( \frac{{T}_{on}}{{T}_{total}} )}_{AP -}$$

The channel usage seen at AP

$$( 0 \leq \frac{{T}_{on}}{{T}_{total}} \leq 1 ) .$$

If current session route is via AP, channel usage shall not include the load from session over current channel.

In another embodiment of the invention the candidate channel is a D2D candidate and the cost function is given by the following equation:

$${CostFunction}_{D 2 D} = \frac{1}{{SINR}_{S \to R} \cdot {BW}_{S , R} \cdot ( 1 - max ( {( \frac{{T}_{on}}{{T}_{total}} )}_{R} , {( \frac{{T}_{on}}{{T}_{total}} )}_{S} ) )}$$

where:
SINR_{S→R}—The SINR in receiver, from sender device to receiver
BW_{S,R}—The channel bandwidth between sender device and receiver device

$${( \frac{{T}_{on}}{{T}_{total}} )}_{R -}$$

The channel usage seen at the receiver

$$( 0 \leq \frac{{T}_{on}}{{T}_{total}} \leq 1 ) .$$

If current session route is via D2D over this channel, channel usage shall not include the load from current channel.

$${( \frac{{T}_{on}}{{T}_{total}} )}_{S -}$$

The channel usage seen at the sender

$$( 0 \leq \frac{{T}_{on}}{{T}_{total}} \leq 1 ) .$$

If current session route is via D2D over this channel, channel usage shall not include the load from current channel.

### BRIEF DESCRIPTION OF THE DRAWINGS

In the drawings:

FIG. 1 schematically shows a local network in which a session's traffic can be passed via AP over two hops (links), or directly between peer devices over single hop (link);

FIG. 2 is a flowchart showing a functional flow within a wireless device, according to one embodiment of the invention;

FIG. 3 schematically illustrates the retrieval of remote peer capabilities can be retrieved during the PtP session initialization phase as part of capabilities exchange operation, in one embodiment of the invention;

FIG. 4 illustrates a high-level link tracking flow according to an embodiment of the invention;

FIG. 5 schematically illustrates the elements of a system operating a link tracking, according to one embodiment of the invention;

FIG. 6 schematically illustrates the collection of statistics/measurements from a specific channel/route, according to an embodiment of the invention; and

FIG. 7 describes a high-level channel selection flow according to one embodiment of the invention.

### DETAILED DESCRIPTION OF THE INVENTION

The invention provides a complete and comprehensive solution, which includes support for smart link tracking and channel selection algorithms taking into account the following aspects:
1. Managing different route of PtP sessions (via AP and direct paths) in a seamless manner to the application and to the user;
2. Optimized to PtP Asymmetric session traffic (such as video, file sharing, etc.) over different routes;
3. Coping with different interference environment as sensed by peer devices;
4. Using state information of transport and application layers to improve the operational mode change decisions;
5. Ensuring service continuation in cases where session is switched to different operational mode (different wireless channels and/or different route).

The invention provides pairwise algorithms for link tracking and wireless channel and route selection, for allowing optimal (i.e. least interfered) operating mode over available routes and channels. The decision of selecting the best connectivity between two near (i.e. radio range of each other) devices, as route and channel, is not a trivial task and involves different parameters, among others: received signal strength indicators, noise and interference over available channels and devices locations (i.e. interference domain), load/utilization over available channels, channel bandwidth available, coding and modulation capabilities, etc. The decision criterion for best connectivity assurance involves two major components:
1. Link (session) tracking—responsible for tracking the link (session) quality between PtP devices; and
2. Channel and route selection—choosing the best channel and route between session peers.

Upon link tracking triggering, which occurs when degraded quality for the current route and channel is detected, for instance as a consequence of congestion or interference over channel, the channel selection component is responsible for identifying a better connectivity option. If such alternative is found, the channel selection triggers the system to migrate the session to the new connectivity option. The new connectivity option may involve a different operating channel and or/route.

Another important aspect is that the session continuation must be maintained while the session is transported between different channels and/or routes. This support is important for connection-oriented transport protocols such as TCP.

Focusing on asymmetric traffic applications between two wireless devices, such as video streaming and FTP session, we define a sender device (the session streaming source) and a receiver device (the session streaming destination). The determination of the identity of the sender and of the receiver device can be given as an input from the application, or can be done on the fly by the system, by sensing the byte stream direction from source to destination.

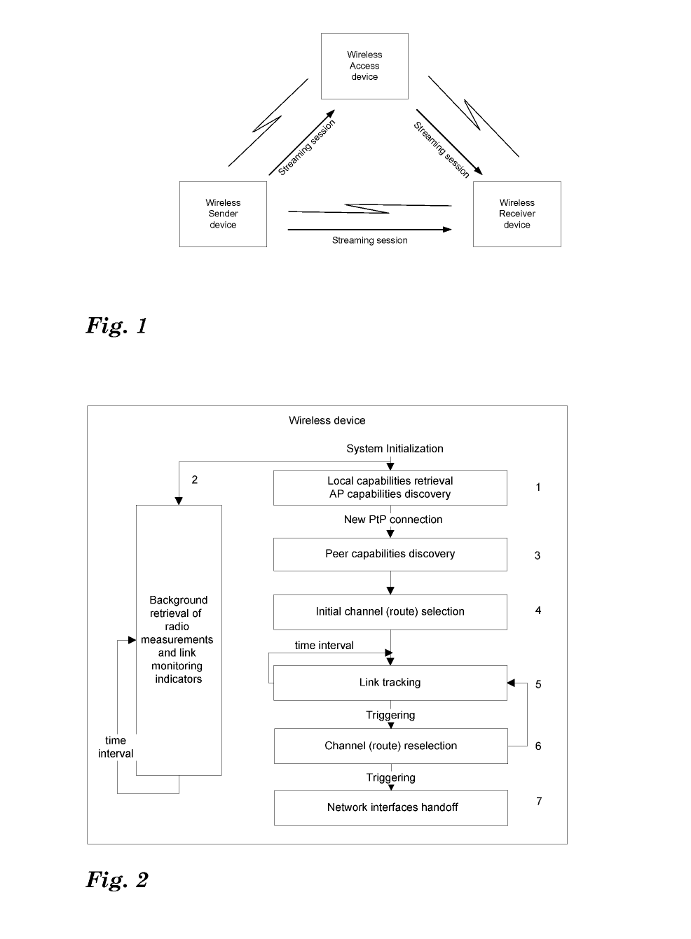

The traffic can be passed via different routes and different wireless channels between sender and receiver. For example, in a local network, as described in FIG. 1, the session's traffic can be passed via AP over two hops (links) or directly between peer devices over single hop (link). The direct connection can be established on a different channel than the AP operational channel. The direct connection may be established on system initialization, or on-the-fly when the route is switched to be through direct path.

The control information exchange between devices related to different subsystems modules solution can be carried over the AP route, or over a direct path, when such one is established.

The flowchart of FIG. 2 presents a functional flow within a wireless device, according to one embodiment of the invention. Referring to the figure, the following numbered steps take place:
1. On system initiation, the application retrieves its local capabilities as well as its associated AP capabilities. Both capabilities are retrieved locally from the device driver. AP capabilities are known from beacon and/or from the negotiation phase taking place during the device association procedure;
2. The background scanning process is used for retrieving relevant radio measurements to be used by channel selection and link tracking subsystems. It is started right after system initialization and is performed periodically, during a given time interval;
3. Upon a new session connection initiation, the peers exchange their capabilities with each other. The common capabilities will be used later as a candidate set for the link tracking and channel selection procedures;
4. The initial channel selection is based on measurements collected over candidate operational modes and optional QoS demands indicators from the application. The algorithm is based on a cost function, that will be further discussed below, which is calculated for each of the operational mode alternatives;
5. During the video streaming session, the link tracking subsystem periodically tracks and assesses if the current link satisfies the video session application, during a given time interval. As long as the current link satisfies the video session, the system continues to operate in the same channel and route. Otherwise, it triggers the channel reselection subsystem to look for a better channel and/or route;
6. The channel selection subsystem is based on the measurements collected over candidate operational mode and optional QoS demands from the application. The algorithm is based on a cost function which is calculated for each of the operational mode alternatives. In a case where the best operational mode available is different than the current one, a seamless handoff procedure is triggered. Thereafter, link tracking is reinitiated over the operational channel;
7. The network interfaces handoff is responsible to ensure application service continuity during application seamless handoff, in case where different network interfaces are used (such as WiFi-Direct and WiFi).

### Capabilities Discovery Subsystem

The capabilities discovery module plays a role as a serving module for other modules in the system, including link tracking, measurements and monitoring and channel selection modules. It is responsible for obtaining and managing the local and remote peers' capabilities as well as their current operational mode. Examples for capabilities parameters include supported frequencies, bands, operational channel (for AP), WiFi standard revision (802.11a/b/g/n/ac), etc.

The shared subset of capabilities of peer devices sharing a link determines the operation mode over that link. As a result, a session's route via AP may have different capabilities characteristics than session's route over direct single link. For example, if the AP supports only 802.11n standard capabilities and each of the devices supports 802.11ac standard capabilities, when the PtP session routes via AP, both links (sender device->AP, AP->receiver device) are enforced to work under the 802.11n standard. However, when the session routes over direct link between devices, 802.11ac standard capabilities can be used for the connection, with potentially added functionality (higher modulation rates, wider bandwidth, etc.).

The capabilities management includes functionality related to capabilities retrieval operations of local capabilities discovery, AP capabilities discovery and remote peer capabilities discovery.

The local capabilities can be retrieved during initialization from the WiFi driver.

The AP capabilities can be retrieved from the device's WiFi driver after association with the WiFi AP.

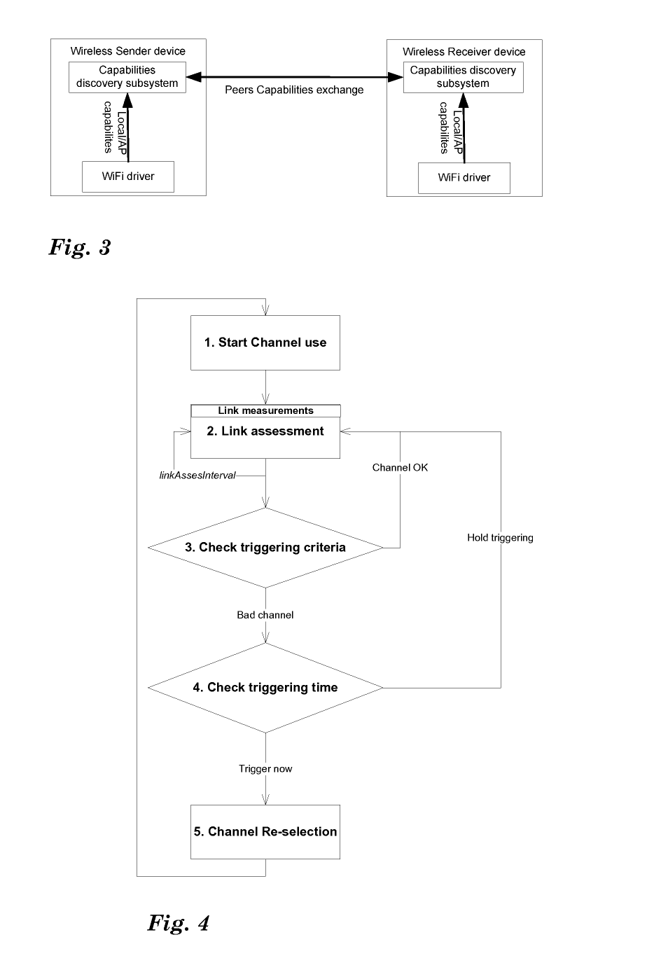

The remote peer capabilities can be retrieved during PtP session initialization phase as part of capabilities exchange operation, as schematically illustrated in FIG. 3.

The capabilities negotiation includes a simple request-respond transaction between devices, in which each device advertises its local supported capabilities.

### Link Tracking Subsystem

The Link Tracking and Triggering subsystem is responsible for monitoring the current operational mode's statistics/measurements. It triggers for channel/route reselection both when a session is active and inactive (but still connected). Tracking during inactivity of an existing PtP connection aims to ensure that when one will be started, the best available route and channel will be already assigned between PtP devices. For an active session, a trigger is initiated when application QoS and/or channel conditions are not satisfied. For an inactive session, a trigger is initiated when channel conditions are not satisfied.

The channel quality and application QoS can be affected by environmental changes, like non-stationary devices positions, obstacles, channel congestion and interference. The subsystem should detect an application performance degradation and automatically trigger channel reselection.

The link tracking system may also track multiple simultaneous sessions between the same peer devices, and trigger the system when one or more sessions' QoS demands do not satisfy. FIG. 4 illustrates a high-level link tracking flow.

### Link Tracking Measurements

During work on a specific channel/route, statistics/measurements are collected for the current operational mode from various layers: application, transport and driver (MAC/PHY) layers. The measurements collection from various layers aims to improve the performance of the link tracking algorithm, including reduction of false positives and shorter response time. Measurements may be different on sender and receiver sides according to their relevancy.

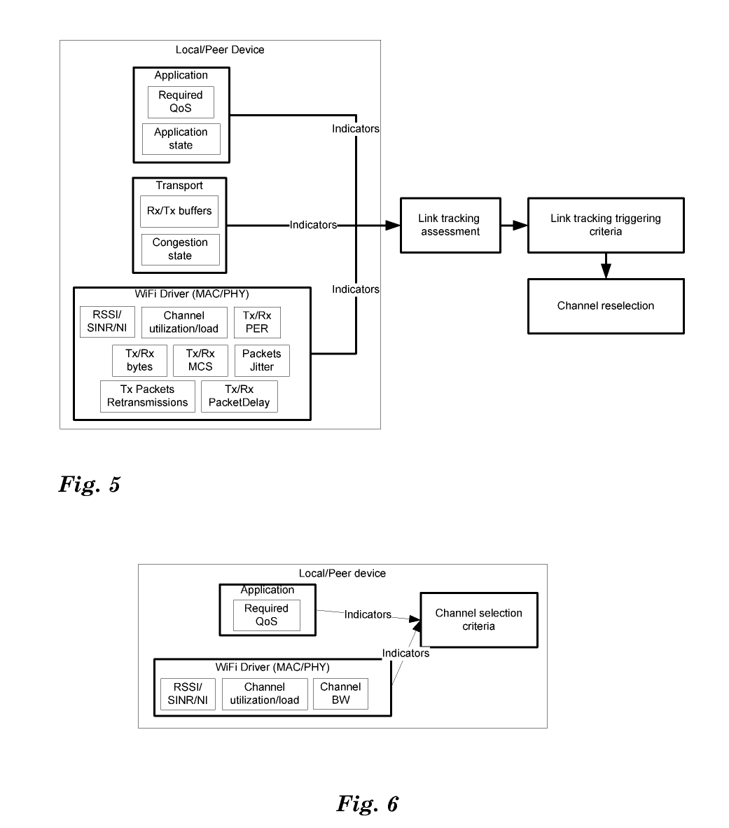

Different combinations of measurements can be gathered, depending of the current operational mode of the system (channel and route) and on application characteristics. Accordingly, different profiles for measurements collection can be defined. For example, a basic profile will include measurement retrieval from WiFi driver level only. Another example can be a profile for video streaming over TCP where measurements are collected from all layers. The elements of a system operating a link tracking, according to one embodiment of the invention, is schematically shown in FIG. 5.

From the WiFi driver, measurements related to link and channel quality are monitored and collected, including indicators related to:
1. RSSI—received signal strength indicator in receiver of a link. RSSI in AP can be, for example, retrieved using 802.11k measurements request reply mechanism.
2. SINR—Signal to Interference and Noise ratio in receiver of a link. SINR in AP can be, for example, retrieved using 802.11k measurements request reply mechanism.
3. NI—Noise and interference in receiver of a link. NI in AP can be, for example, retrieved using 802.11k measurements request reply mechanism.
4. Channel load/utilization—the load over the current used channel as defined in 802.11 standard.
5. Tx/Rx PER—Packet error rate on sender and receiver of a link.
6. Tx/Rx MCS—Modulation coding scheme on sender and receiver of a link.
7. Tx/Rx bytes—Number of sent and received bytes over a link
8. Tx Packets retransmission—packets retransmission of link sender.
9. Tx/Rx packets delay—in Tx/Rx queues.
10. Tx/Rx packets jitter—in a link device.

When session routes via AP, measurements are collected on both route links

(Sender device->AP, Receiver device->AP).

From the transport layer, measurements related to session quality are monitored and collected, including indicators relating to:
1. Rx/Tx buffer state—the state of send and receive buffers.
2. Congestion state—for reliable transport protocols, the state of the congestion, such as TCP window size.

From the application layer, measurements related to session quality are monitored and collected, including indicators relating to:
1. Application state—the state of application such Tx/Rx buffer state, congestion, delay, segments drop, etc.
2. Required QoS—Initial required QoS indicators such as throughput, delay tolerance, etc.

The collected measurements are processed during the link assessment phase. Processing includes statistical calculations of indicators such as averaging, standard deviation, median, both for long term and short term time intervals.

When the session routes via AP, the monitoring of link quality on operational channel is done for two hops. The sender device tracks the sender-AP link and the receiver device tracks the AP-receiver link. When the session routes via direct path, the monitor of link quality on operational channel is done for sender-receiver link by either the sender or receiver devices.

If link tracking functionality is implemented in a single device, either the receiver device or receiver sender, measurements can be exchanged between devices.

### Link Tracking Criteria

Every predefined time interval, based on the most updated calculated data of measurements, a series of triggering criteria are checked. Triggering criteria includes the comparison of one, or combination or two or more of the calculated data related to predetermine thresholds.

Some triggering examples:
The averaged channel load exceeds a maximum threshold and the observed throughput degrades below a minimum threshold.
The link quality, based on PER and modulation, drops below a minimum threshold.
The long term averaged channel usage exceeds maximum threshold.

Triggering can be initiated from both the receiver and sender devices.

The set of checked triggering criteria can be different for different session routes and for different types and streaming characteristics of applications.

If one of the triggers occurs and enough time passed from previous trigger time, the channel reselection procedure is executed. Previous trigger time is checked in order to ensure minimum time between two triggering events—for decision reliability and to avoid zigzagging between two operational modes.

### Channel/Route Selection Subsystem

The channel selection module is responsible for obtaining the best operational channel and route for both initial and ongoing PtP session.

Two route alternatives are supported for selection; via AP and D2D:
For AP route, the AP operational channel may be controlled by the system among the supported channels.
For D2D, the selection of the channel is controlled by the system among the supported channels.

The initial channel selection functionality includes the selection of an operational channel and route at new PtP session initiation phase.

The channel selection functionality can be activated over either receiver side or sender side or both, with the support of measurements obtained from both sides. In case of channel selection decision on a device, the peer device is being informed on the switching decision. The peer device than acknowledge the procedure.

If the channel selection functionality is implemented in a single device, either the receiver device or sender device, measurements can be exchanged between devices.

For ensuring fast convergence channel selection algorithm, the process of measurements parameters retrieval is being done as continuous background process, so that upon channel triggering, all required information for selection will be available.

### Channel Selection Measurements

During work on a specific channel/route, statistics/measurements are collected for every candidate operational mode (channel and/or route) from the application and WiFi driver (MAC/PHY) layers. Measurements may be different on sender and receiver sides, according to their relevancy. Different combination of measurements can be gathered depending of the current operational mode of the system (channel and route). This process is schematically illustrated in FIG. 6, for one embodiment of the invention.

From the WiFi driver, measurements related to link and channel quality are monitored and collected, including indicators relating to:
1. RSSI—received signal strength indicator in receiver of a link.
2. SINR—Signal to Noise ratio in receiver of a link.
3. NI—Noise and interference in receiver of a link.
4. Channel load/utilization—the load over the candidate channel as defined in 802.11k standard.
5. Channel BW—candidate channel bandwidth.

From the application layer, measurements related to session quality are being monitored and collected, including indicators relating to:

1. Required QoS—Initial required QoS indicators such as throughput, delay tolerance, etc.

### Channel Selection Criteria

The channel selection criteria are based on a cost function. The cost function value reflects the time required to send the same number of bytes over different candidate routes and channels between PtP devices. For session through AP, the cost function is calculated over the operational channel of the AP. For session over direct path, the cost function is calculated for every candidate operational channel.

For example, for a candidate session route via AP, the cost function can be given by the following equations:

$${CostFunction}_{AP} = [ \begin{matrix}\frac{1}{{SINR}_{S \to AP} \cdot {BW}_{S , AP} ( 1 - max ( {( \frac{{T}_{on}}{{T}_{total}} )}_{S} , {( \frac{{T}_{on}}{{T}_{total}} )}_{AP} ) )} + \\ \frac{1}{{SINR}_{AP \to R} \cdot {BW}_{AP , R} \cdot ( 1 - max ( {( \frac{{T}_{on}}{{T}_{total}} )}_{R} , {( \frac{{T}_{on}}{{T}_{total}} )}_{AP} ) )}\end{matrix}$$

### Where:

SINR_{S→AP}—The SINR in AP from sender device to AP
BW_{S,AP}—The channel bandwidth between sender device and AP
SINR_{AP→R}—The SINR in receiver device from AP to receiver device
BW_{AP,R}—The channel bandwidth between AP and receiver device

$${( \frac{{T}_{on}}{{T}_{total}} )}_{R -}$$

The channel usage seen at the receiver

$$( 0 \leq \frac{{T}_{on}}{{T}_{total}} \leq 1 ) .$$

If current session route is via AP, channel usage shall not include the load from session over current channel.

$${( \frac{{T}_{on}}{{T}_{total}} )}_{S -}$$

The channel usage seen at the sender

$$( 0 \leq \frac{{T}_{on}}{{T}_{total}} \leq 1 ) .$$

If current route is via AP, channel usage shall not include the load from session over current channel.

$${( \frac{{T}_{on}}{{T}_{total}} )}_{AP -}$$

The channel usage seen at AP

$$( 0 \leq \frac{{T}_{on}}{{T}_{total}} \leq 1 ) .$$

If current session route is via AP, channel usage shall not include the load from session over current channel.

For a D2D candidate, the cost function for a candidate channel can be given by the following equation:

$${CostFunction}_{D 2 D} = \frac{1}{{SINR}_{S \to R} \cdot {BW}_{S , R} \cdot ( 1 - max ( {( \frac{{T}_{on}}{{T}_{total}} )}_{R} , {( \frac{{T}_{on}}{{T}_{total}} )}_{S} ) )}$$

### Where:

SINR_{S→R}—The SINR in receiver, from sender device to receiver
BW_{S,R}—The channel bandwidth between sender device and receiver device

$${( \frac{{T}_{on}}{{T}_{total}} )}_{R -}$$

The channel usage seen at the receiver

$$( 0 \leq \frac{{T}_{on}}{{T}_{total}} \leq 1 ) .$$

If current session route is via D2D over this channel, channel usage shall not include the load from current channel.

$${( \frac{{T}_{on}}{{T}_{total}} )}_{S} .$$

The channel usage seen at the sender

$$( 0 \leq \frac{{T}_{on}}{{T}_{total}} \leq 1 ) .$$

If current session route is via D2D over this channel, channel usage shall not include the load from current channel.

In order to normalize the channel usage over current operational mode (where the session currently traverse through) and other operational modes, the self-usage introduced by ongoing sessions shall be subtracted from the total channel usage measured over the current operational mode.

Upon triggering, the channel selection algorithm runs over every candidate channel and route and calculates the relevant cost function. The route and channel yielding the lowest cost function is selected as the next operational channel and route of the PtP session.

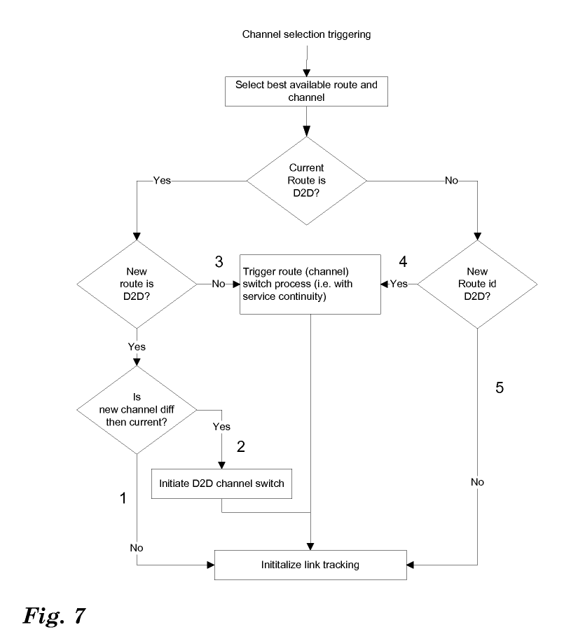

FIG. 7 describes high-level channel selection flow according to one embodiment of the invention.

The following are possible channel selection outcomes:
Current route via D2D
   1. No better channel and route exist for route over D2D connection.
   2. A better channel is found over the same D2D connection.
   3. A better route is found via AP.
Current route via AP
   4. A better route (and possibly channel) exists via D2D connection.
   5. No better channel and route found.

The use of cost functions is well known in the art for a variety of uses and the skilled person will devise the appropriate cost function for a given purpose. Illustrative examples of the use of cost functions (also referred to in the literature as “rank”, “price”, etc., depending on the field of use) can be found, e.g., in Arunesh Mishra, Suman Banerjee and William Arbaugh, “Weighted Coloring based Channel Assignment for WLANs”, ACM SIGMOBILE Mobile Computing and Communications Review, Vol. 9, issue 3, pp. 19-31; Krishna N. Ramachandran, Elizabeth M. Belding, Kevin C. Almeroth and Milind M. Buddhikot, “Interference-Aware Channel Assignment in Multi-Radio Wireless Mesh Networks”, 2006 Proceedings IEEE Infocom; Bruno Kauffmann, Francois Baccelli, Augustin Chaintreau, Vivek Mhatre, Konstantina Papagiannaki and Christophe Diot, “Measurement-Based Self Organization of Interfering 802.11 Wireless Access Networks”, IEEE Infocom 2007 proceedings; and, Dusit Niyato and Ekram Hossain, “Cognitive Radio For Next Generation Wireless Networks: An Approach To Opportunistic Channel Selection In IEEE 802.11-Based Wireless Mesh”.

The invention may also exploit a continuity mechanism, such as the “IPIP tunneling” mechanism (http://en.wikipedia.org/wiki/IP_tunnel), in order to ensure session continuity. Such mechanisms enable to switch the actual operation's network interface without breaking live TCP session, thus ensuring session continuity.

As will be apparent to the skilled person, the invention provides a comprehensive method and system for optimizing PtP streaming sessions in interfered and congested local wireless area network. The system is composed of two core subsystems, namely the link tracking and channel selection, which are responsible for ensuring the best available user experience by dynamically switching between different operational systems routes and channels alternatives.

1. A method for maintaining the best available quality of a connection between to wireless-enabled devices in a local wireless network, comprising providing:
(a) a link (session) tracking subsystem, for tracking the link (session) quality between PtP devices; and
(b) a channel and route selection subsystem, for choosing the best channel and route between session peers;
and switching to a different channel and/or route when a measured quality indicator triggers a change.

2. The method according to claim 1, wherein during work on a specific channel/route, statistics/measurements are collected for every candidate operational mode (channel and/or route) from the application and WiFi driver (MAC/PHY) layers, and wherein said measurements are used to trigger a change.

3. The method according to claim 2, wherein measurements and combinations thereof are gathered either on the sender side, or on the receiver side, or on both sides.

4. The method according to claim 1, wherein the channel selection criteria are based on a cost function.

5. The method according to claim 4, wherein the candidate session route is via AP and the cost function is given by the following equations:
$${CostFunction}_{AP} = [ \begin{matrix}\frac{1}{{SINR}_{S -> AP} \cdot {BW}_{S , AP} ( 1 - max ( {( \frac{{T}_{on}}{{T}_{total}} )}_{S} , {( \frac{{T}_{on}}{{T}_{total}} )}_{AP} ) )} + \\ \frac{1}{{SINR}_{AP -> R} \cdot {BW}_{AP , R} \cdot ( 1 - max ( {( \frac{{T}_{on}}{{T}_{total}} )}_{R} , {( \frac{{T}_{on}}{{T}_{total}} )}_{AP} ) )}\end{matrix}$$
wherein:
SINR_{S→AP} is the SINR in AP from sender device to AP;
BW_{S,AP} is the channel bandwidth between sender device and AP;
SINR_{AP→R} is the SINR in receiver device from AP to receiver device;
BW_{AP,R} is the channel bandwidth between AP and receiver device;
$${( \frac{{T}_{on}}{{T}_{total}} )}_{R}$$
is the channel usage seen at the receiver
$$( 0 \leq \frac{{T}_{on}}{{T}_{total}} \leq 1 ) ,$$
and if current session route is via AP, channel usage shall not include the load from session over current channel;
$${( \frac{{T}_{on}}{{T}_{total}} )}_{S}$$
is the channel usage seen at the sender
$$( 0 \leq \frac{{T}_{on}}{{T}_{total}} \leq 1 ) ,$$
and if current route is via AP, channel usage shall not include the load from session over current channel;
$${( \frac{{T}_{on}}{{T}_{total}} )}_{AP}$$
is the channel usage seen at AP
$$( 0 \leq \frac{{T}_{on}}{{T}_{total}} \leq 1 ) ,$$
and if current session route is via AP, channel usage shall not include the load from session over current channel.

6. The method according to claim 1, wherein the candidate channel is a D2D candidate and the cost function is given by the following equation:
$${CostFunction}_{D 2 D} = \frac{1}{{SINR}_{S -> R} \cdot {BW}_{S , R} \cdot ( 1 - max ( {( \frac{{T}_{on}}{{T}_{total}} )}_{R} , {( \frac{{T}_{on}}{{T}_{total}} )}_{S} ) )}$$
where:
SINR_{S→R} is the SINR in receiver, from sender device to receiver;
BW_{S,R} is the channel bandwidth between sender device and receiver device;
$${( \frac{{T}_{on}}{{T}_{total}} )}_{R}$$
is the channel usage seen at the receiver
$$( 0 \leq \frac{{T}_{on}}{{T}_{total}} \leq 1 ) ,$$
and if current session route is via D2D over this channel, channel usage shall not include the load from current channel;
$${( \frac{{T}_{on}}{{T}_{total}} )}_{S}$$
is the channel usage seen at the sender
$$( 0 \leq \frac{{T}_{on}}{{T}_{total}} \leq 1 ) ,$$
and if current session route is via D2D over this channel, channel usage shall not include the load from current channel.
